(19) United States
(12) Patent Application Publication
(10) Pub. No.: US 2014/0325163 A1
(43) Pub. Date: Oct. 30, 2014

(54) Cross-Partition Shared Memory Attach for Data Processing Environment

(71) Applicant: INTERNATIONAL BUSINESS MACHINES CORPORATION, Armonk, NY (US)

(72) Inventor: Richard Louis Arndt, Austin, TX (US)

(73) Assignee: INTERNATIONAL BUSINESS MACHINES CORPORATION, ARMONK, NY (US)

(21) Appl. No.: 13/870,103

(22) Filed: Apr. 25, 2013

(51) Int. Cl. G06F 12/10; G06F 3/06

(52) U.S. Cl. CPC G06F 12/1036; G06F 3/0644; G06F 3/0673; G06F 3/0604
USPC 711/153

(57) ABSTRACT

A technique for managing shared memory includes linking address translation data structures used by first and second sharing applications. The first sharing application is managed by a first operating system (OS) and the second sharing application is managed by a second OS that hosts an associated virtual object. Virtual addresses of the first and second sharing applications are bound, based on the linking, to a changeable set of physical addresses that the second OS assigns to the associated virtual object such that the associated virtual object, which is shared by the sharing applications, is pageable by the second OS without permission of the first OS.

### BACKGROUND

The disclosure generally relates to a data processing environment and, more specifically, to a cross-partition shared memory attach for a data processing environment.

When a process (that has its own address space and unique user space) needs to communicate with another process (that has its own address space and unique user space) the process may send a request to the kernel to allocate memory space for inter-process communication (IPC). A process may also communicate with another process via a file that is accessible to both of the processes. However, requiring a process to open and read/write a file to communicate with another process usually requires multiple input/output (I/O) operations that may consume an undesirable amount of time.

In UNIX®, there are also various IPCs that allow processes to communicate with other processes, either in a same data processing system or a different data processing system in a same network. For example, ‘pipes’ provide a way for processes to communicate with each other by exchanging messages. As another example, ‘named pipes’ provide a way for processes running on different data processing systems to communicate over a network. As still another example, processes can exchange values in shared memory. In this case, one process designates a portion of memory that other process can access. As yet another example, processes may communicate with other processes using message queues, which are structured and ordered lists of memory segments where processes store or retrieve data. Additionally, processes may also communicate with other processes using semaphores, which provide a synchronizing mechanism for processes that are accessing the same resource. In general, a semaphore simply coordinates access to shared resources. That is, no data is passed between processes with a semaphore.

A UNIX shared memory attach (SHMAT) command or function may also be utilized to attach an identified shared memory segment to an address space of a calling process, such that one process may communicate with another process. Conventional SHMAT allows processes running under an OS to simultaneously perform fine-grained load and/or store accesses at the byte level to the same memory locations. That is, conventional SHMAT is restricted to operating within the context of a single OS. Conventional shared/cluster file systems are known that are configured to bring an object into local memory space of one processor, where the processor can make updates to the object. When the processor has finished updating the object, the entire object is then subsequently moved to a local memory of a sharing processor.

In a first conventional system, data is always returned to its home in non-volatile file system storage (e.g., a disk). In a second conventional system, data may be copied directly from local memory of a first user to local memory of a second user. In the second conventional system, accessing a virtual object has involved pinning the object in storage, initiating input/output (I/O) operations (usually involving direct memory access (DMA)) on both a sender and a receiver, and processing an “operation complete” interrupt before a sharing processor can initiate updates to the object.

A third conventional system is essentially a cluster version of a virtualized symmetric multi-processor (SMP) machine. In the third conventional system, each machine can physically address memory of the entire system. In this case, the entire system memory is divided among OSs that run on the system, and mechanisms are normally implemented that prevent one OS from accessing memory assigned to another OS. While the mechanisms can be circumvented, conventionally the circumventions have provided operating system ‘A’ access to physical addresses assigned to operating system ‘B’, as contrasted with virtual addresses. In general, applications executing in a virtual memory OS do not utilize physical addresses. That is, an application accesses an offset within a virtual object, which is what is represented by a virtual address (VA). Typically, only a local OS understands the ever changing relationship between VAs generated by an application and underlying machine physical addresses. A current snapshot of at least a subset of this relationship is usually captured by a local OS in address translation tables of a local machine.

### BRIEF SUMMARY

A technique for managing shared memory includes linking address translation data structures (e.g., tables) used by first and second sharing applications. The first sharing application is managed by a first operating system (OS), and the second sharing application is managed by a second OS that hosts an associated virtual object. Virtual addresses of the first and second sharing applications are bound, based on the linking, to a changeable set of physical addresses that the second OS assigns to the associated virtual object such that the associated virtual object, which is shared by the sharing applications, is pageable by the second OS without permission of the first OS.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein:

FIG. 1 is a diagram of a relevant portion of an exemplary data processing system environment that includes a data processing system that is configured to implement a cross-partition shared memory attach (XSHMAT) according to the present disclosure;

FIG. 2 is a diagram of a relevant portion of a conventional data processing system that performs conventional UNIX communications between two operating system images using a virtual communication device;

FIG. 3 is a diagram of a relevant portion of a data processing system configured according to an embodiment of the present disclosure to perform an XSHMAT;

FIG. 4 is a diagram of a relevant portion of a data processing system configured according to another embodiment of the present disclosure to perform an XSHMAT, where a right-most operating system (OS) image maintains a virtual object that is shared between applications executing in different OS images;

FIG. 5 is a diagram of a relevant portion of a data processing system configured according to another embodiment of the present disclosure to perform an XSHMAT, where a left-most OS image maintains a virtual object that is shared between applications executing in different OS images;

FIG. 6 is a diagram of a relevant portion of a data processing environment configured according to another embodiment of the present disclosure to perform an XSHMAT, where a right-most OS image maintains a virtual object that is shared between applications executing in different OS images on different data processing systems;

FIG. 7 is a diagram of a relevant portion of a data processing environment configured according to another embodiment of the present disclosure to perform an XSHMAT, where a left-most OS image maintains a virtual object that is shared between applications executing in different OS images on different data processing systems; and

FIG. 8 is a flowchart of an exemplary process for sharing memory according to one embodiment of the present disclosure.

### DETAILED DESCRIPTION

The illustrative embodiments provide a method, a data processing system, and a computer program product (embodied on a computer-readable storage device) for performing a cross-partition shared memory attach (XSHMAT).

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

It is understood that the use of specific component, device, and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

According to the present disclosure, a cross-partition shared memory attach (XSHMAT) command/function is disclosed that extends the semantics of a conventional UNIX SHMAT command to function among all processes of all operating system (OS) images of a data processing environment that may include a number of interconnected data processing systems. In general, the conventional SHMAT command is limited to sharing memory among processes of a single OS image. Conventional approaches to sharing memory among all processes of all OS images of interconnected data processing systems have required that shared system storage be pinned (i.e., shared system storage is not paged). The pinned memory requirement of the conventional approaches to sharing memory presents a scalability problem, since the number of sharing processes is limited by the pinned physical memory required for the shared memory. While shared memory among processes executing in a single UNIX OS image is pageable with SHMAT, shared memory among processes executing in different OS images (partitions) is not pageable with SHMAT.

According to an aspect of the present disclosure, portions of virtual memory translation of OS images that represent shared memory are linked, such that memory accesses can fault and memory access faults can be directed to an OS image that created the shared memory segment (and is responsible for resolving a translation/page fault). Conventional SHMAT ties the virtual address (VA) translation of two processes that share common virtual storage together, such that when the two processes access the common virtual storage the access is made using a common portion of address translation tables of a common OS. According to the present disclosure, address translation data structures (e.g., tables) of multiple different OSs are linked in a virtualized machine. Address translation tables of multiple different OSs may be linked in a virtualized machine in a number of ways. As one example, when two or more sharing OSs are executing in a single symmetric multi-processor system, hypervisor page table trees (HPTTs) of different OSs may be linked via a cross-partition descriptor (CPD). In one or more embodiments, when the sharing OSs are running in separate systems, HPTTs of different OSs may be linked with a requestor proxy and a receiver proxy (e.g., both implemented in hardware) using a CPD.

According to the present disclosure, techniques are disclosed that implement distributed shared memory in data processing systems (e.g., POWER® systems) that generally provide a more efficient way for different OSs to share memory using a UNIX SHMAT-like interface. According to one embodiment, a modified SHMAT interface is disclosed that uses a cross-partition descriptor (CPD) to map a virtual address (VA) from a non-hosting OS (i.e., an OS that is not hosting a virtual object that is to be shared) to an HPTT (and shared memory offset within the HPTT) maintained by an OS that hosts the virtual object that is to be shared. The use of a CPD allows an OS to use shared memory (i.e., access a shared virtual object) without having to consider paging. In this case, the hosting OS handles any changes in translation between the VA and a physical address. In this manner, the VA of the shared memory is kept constant. An advantage of the disclosed technique is that the memory does not have to be pinned or copied (e.g., using a direct memory access (DMA)) back and forth between partitions, as is done in conventional systems. In general, avoiding pinning and copying memory between partitions provides performance and scalability improvements.

According to one or more aspects, address translation data structures (e.g., tables) used by a sharing application (and managed by an OS that hosts the sharing application) are linked to address translation data structures (e.g., tables) of an OS that hosts a shared virtual object. The linkage facilitates late binding of a VA of an application to an ever changing set of physical addresses that a hosting OS assigns to the virtual object. This late binding allows a shared virtual object to be paged by a hosting OS without permission of OSs that do not host the shared virtual object. In this case, OSs do not need to keep track of physical addresses being shared. It should be appreciated, however, that a hosting OS needs to update mappings of VAs to physical addresses as paging occurs. As previously noted, conventional approaches have performance drawbacks as memory must be pinned, DMAs are required to be performed (back and forth) between partitions, and/or locking is required at a software level. In general, the disclosed approaches provide a relatively straight forward technique for allowing software to share memory efficiently.

In the conventional SHMAT case, a local OS allows two or more sets of VAs to reference the same virtual object. The local OS can allow two or more sets of VAs to reference the same virtual object because the local OS is in charge of placing at least a subset of the virtual object into physical memory and creating the address translation table entries that map the various VAs used by the sharing applications to the physical addresses in memory that currently store the virtual object. This memory sharing technique works satisfactory when the sharing applications are running under a single OS image, but does not work satisfactory when the sharing applications are running under different OS images. If sharing applications are running under different OS images, conventional approaches have implemented a shared/cluster file system that copies a virtual object to memory of one of the OSs of the sharing applications. The sharing application then processes the virtual object before copying the virtual object to memory of the other sharing application.

Alternatively, multiple OSs that are hosting multiple applications may conventionally set-up their address translation tables to map each of the VAs of the sharing applications to the same virtual object. Conventional approaches for allowing multiple applications in multiple OS images to share a single virtual object have utilized a common physical address space between all the OS images. In this case, each OS then must cooperate to create respective address translation table entries that map various VAs to the physical addresses that include the single shared virtual object.

In the general case, the level of cooperation needed to manage an ever changing relationship between the VAs generated by an application and the underlying machine physical addresses and varying subsets of the virtual object (that represent a working set of the virtual object) as they are brought in and paged out of physical storage has been an intractable problem. The conventional solution has been to bring the entire shared virtual object into physical memory and ‘pin’ the virtual object in memory so that the relationship between the VAs generated by an application and the underlying machine physical addresses are constant. While pinning a virtual object in memory renders the required cooperation tractable, pinning a virtual object introduces scaling problems as shared virtual objects become large and numerous and, as such, the solution can only be applied in limited cases.

In contrast to conventional SHMAT, a data processing system configured according to the present disclosure allows processes running under different OSs to simultaneously perform fine-grained load and/or store accesses at the byte level to the same memory locations and also extends the conventional SHMAT functionality to operate across multiple OSs. According to one or more embodiments of the present disclosure, instead of placing the physical address that includes data for the virtual object in the address translation table entries for the shared virtual object, the local OS places the offset into the shared virtual object and a pointer to a cross-page table descriptor. The cross-page table descriptor includes a pointer to the page table managed by the OS image that is hosting the virtual object and the VA of the origin of the shared virtual object in the virtual address space of the OS hosting the sharing application. In this case, the entire shared virtual object can be mapped at a constant VA in the virtual address space of the hosting OS, with the hosting OS managing the paging of the current working set into physical memory and only needing to update its own address translation tables since any sharing application accesses the shared virtual object through the translation table managed by the hosting OS. In this case, the problem of scaling as the shared virtual objects become large and numerous are solved and the solution can be applied to virtually an unlimited numbers of cases.

According to one aspect of the present disclosure, address translation tables used by sharing applications and managed by the OS hosting the sharing applications are linked to the address translation tables of the OS that is hosting the virtual object. The linkage facilitates late binding of a VA of an application to the ever changing set of physical addresses that the hosting OS assigns the virtual object data. This binding allows the shared virtual object to be paged by the hosting OS without the permission of the OSs hosting the sharing applications. As noted above, cross-partition shared memory attach (XSHMAT) borrows from conventional SHMAT semantics. XSHMAT maps a portion of an effective (or virtual) address space of Partition ‘A’ process ‘a’ into the effective (or virtual) address space of Partition ‘B’ process ‘b’. XSHMAT relies on an extension to memory management unit (MMU) translation mechanisms to advantageously remove a hypervisor from the performance path. As noted above, conventional solutions, which have mapped and/or connected and/or DMA'd physical memory underneath a partition (or process) virtual (or effective) address space have created scalability and/or virtualization issues that required additional data copies and/or channel swapping software to manage a complicated system structure.

A syntax for XSHMAT may be similar to SHMAT. For example, cross-partition shared memory attach functionality, according to the present disclosure, may be implemented using the following exemplary functions:

void XSHMAT(int xshmid, const void *shmaddr, int xshmflg);

In the above case, XSHMAT sets up a cross-partition share memory attach, where ‘xshmid’ is a token identifying the registered shared virtual memory object, ‘*shmaddr’ is the address in the sharing process's virtual address space where the shared virtual memory object is to be mapped, and ‘xshmflg’ is a set of options such as “read only” etc. As another example, XSHMDT, which unmaps a cross-partition shared memory address space, may be implemented as:

int XSHMDT(const void *shmaddr);

As another example, XSHMGET, which creates or gets an identifier (ID) of a cross-partition shared memory address space, may be implemented as:

int XSHMGET(xkey_t xkey, int size, int xshmflg);

In the above case, ‘xkey_t xkey’ is the argument specifying the creation or connection with an existing virtual memory object and ‘size’ is the size of the virtual memory object. As a final example, XSHMCTL, which controls a cross-partition shared memory address space, may be implemented as:

int XSHMCTL(int xshmid, int cmd, struct xshmid_ds *buf);

In the above, case, ‘cmd’ is the token indicating which control operation to perform on the specified shared virtual memory object (such as “change the access protection setting”), and ‘xshmid_ds *buf’ is a pointer to a descriptor structure associated with the shared virtual memory object.

Once a cross-partition shared memory address space is attached to a user process, data may be transferred via a load, store, or cache inject copy operation. When partitions are located in different data processing systems, any technique that provides a cookie that represents an authorized channel between the partitions from a virtual local area network (VLAN) switch should facilitate implementing the disclosed techniques.

For example, a hypervisor call (e.g., hcall( )) function may be used to register and rescind cross-partition shared memory. As one example, registration may be initiated using an exemplary function ‘H_REGISTER_XSHMEM’ that has associated information (e.g., an authorized channel cookie, a page aligned starting virtual address, a length) and returns ‘xshmid’. As another example, a rescind may be initiated using an exemplary function ‘H_RESCIND_XSHMEM’ that specifies ‘xshmid’. A process may attach to the created cross-partition using an exemplary function ‘H_ATTACH_XSHMEM’, which specifies ‘xshmid’ and receives a starting guest real page address and length. The process may then detach itself from the cross-partition using an exemplary function ‘H_DETACH_XSHMEM’, which specifies ‘xshmid’. Hardware may determine that it is processing a cross-partition descriptor (CPD) through a number of different ways. For example, a tree-structured page table may implement two kinds of valid entries as follows: L=1, includes protection/mode bits and points to a translated page; and L=0, points to another level of translation. Other lower-order bits may be ‘decoration’ that indicates to hardware a format for the level of translation (e.g., decoration: 0b0000000000 page table; 6-bit PG offset 0x1 CPD; with reserved bits). A CPD configured according to the present disclosure may include: mode bits, e.g., a valid bit, a local/remote bit, and a resolved bit (indicating a VA has been resolved to a physical address); a creating guest virtual page number; a sharer permissions/key; a logical real address of a creating guest page table root; a physical address of host page table root for creating a guest proxy address; and software fields that include a reference count (used to determine when all processes are no longer utilizing a virtual object), lock bits, and a sibling pointer.

Faults in the sharing translation path (page table tree) may include: a sharing guest page table fault, e.g., standard data storage interrupt (DSI) to sharing guest OS; a sharing host page table fault, e.g., standard hypervisor DSI (HDSI) to host; a cross-partition descriptor fault, e.g., a DSI to sharing guest OS with new DSI status register (DSISR) bits; a rescinded memory fault when an attached OS does an H_DETACH_XSHMEM; a remote unresolved fault when an OS does a hypervisor call to allocate proxy channel, etc.; a creating guest/host page table fault, e.g., DSI to sharing; a guest OS with new DSISR bit following an inter-partition message to a creating guest; and an OS that touches a page to correct a fault when an inter-partition message sent back to a sharing guest indicates a fault was corrected and a restart is required.

In general, implementing XSHMAT functionality provides an unlimited number of inter-partition communication pipes and is ideal for ‘super sockets’. Implementing XSHMAT functionality also removes the hypervisor from the communications performance path. XSHMAT functionality builds upon logical extensions to memory management unit (MMU) and fault handling support. Moreover, XSHMAT functionality scales with the number of cores and saves bandwidth that may be needed to communicate with an independent accelerator.

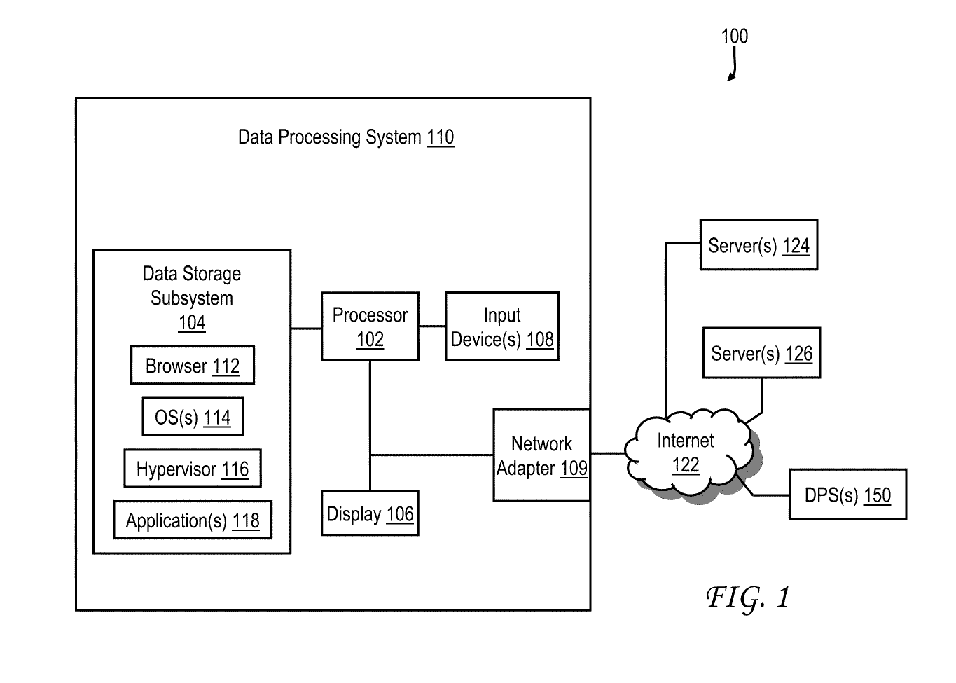

With reference to FIG. 1, an exemplary data processing environment 100 is illustrated that includes a data processing system 110 that is configured, according to one or more embodiments of the present disclosure, to perform cross-partition shared memory attach (XSHMAT). Data processing system 110 may take various forms, such as workstations, laptop computer systems, notebook computer systems, desktop computer systems or servers and/or clusters thereof. Data processing system 110 includes one or more processors 102 (which may include one or more processor cores for executing program code) coupled to a data storage subsystem 104, optionally a display 106, one or more input devices 108, and a network adapter 109. Data storage subsystem 104 may include, for example, application appropriate amounts of various memories (e.g., dynamic random access memory (DRAM), static RAM (SRAM), and read-only memory (ROM)), and/or one or more mass storage devices, such as magnetic or optical disk drives.

Data storage subsystem 104 includes one or more operating systems (OSs) 114 for data processing system 110. Data storage subsystem 104 also includes application programs, such as a browser 112 (which may optionally include customized plug-ins to support various client applications), a hypervisor (or virtual machine monitor (VMM)) 116 for managing one or more virtual machines (VMs) as instantiated by different OS images, and other applications (e.g., a word processing application, a presentation application, and an email application) 118.

Display 106 may be, for example, a cathode ray tube (CRT) or a liquid crystal display (LCD). Input device(s) 108 of data processing system 110 may include, for example, a mouse, a keyboard, haptic devices, and/or a touch screen. Network adapter 109 supports communication of data processing system 110 with one or more wired and/or wireless networks utilizing one or more communication protocols, such as 802.x, HTTP, simple mail transfer protocol (SMTP), etc. Data processing system 110 is shown coupled via one or more wired or wireless networks, such as the Internet 122, to various file servers 124 and various web page servers 126 that provide information of interest to the user of data processing system 110. Data processing environment 100 also includes one or more data processing systems 150 that are configured in a similar manner as data processing system 110. In general, data processing systems 150 represent data processing systems that are remote to data processing system 110 and that may execute OS images that are linked to one or more OS images executing on data processing system 110 via an XSHMAT configured according to the present disclosure.

Those of ordinary skill in the art will appreciate that the hardware components and basic configuration depicted in FIG. 1 may vary. The illustrative components within data processing system 110 are not intended to be exhaustive, but rather are representative to highlight components that may be utilized to implement the present invention. For example, other devices/components may be used in addition to or in place of the hardware depicted. The depicted example is not meant to imply architectural or other limitations with respect to the presently described embodiments.

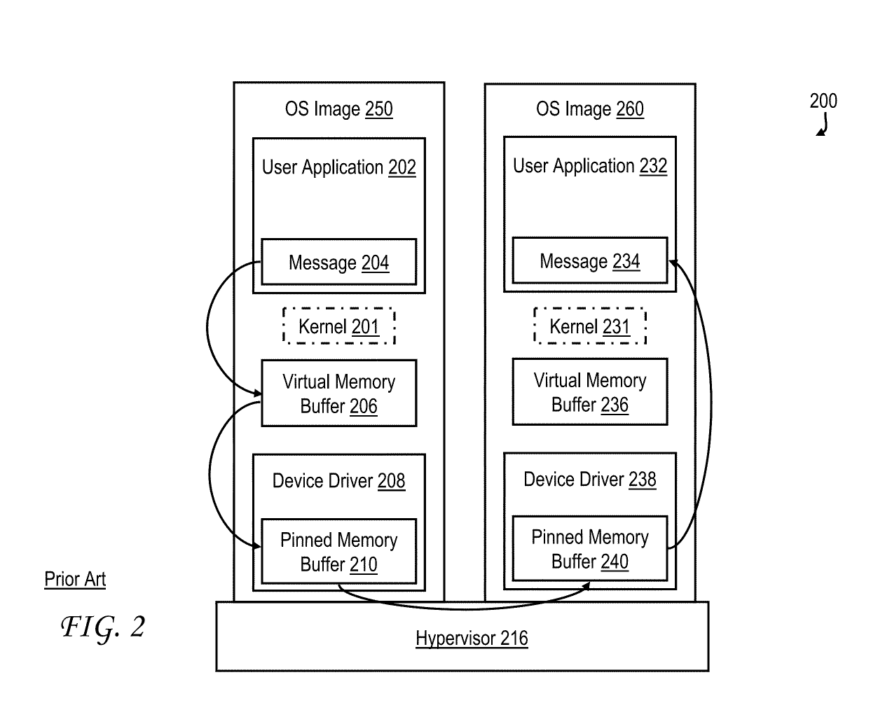

With reference to FIG. 2, a relevant portion of a conventional data processing system 200 is illustrated that implements a hypervisor 216 that facilitates data sharing between respective applications associated with OS images 250 and 260. As is illustrated, OS image 250 includes a kernel 201, a user application 202 (that includes a message queue 204), a virtual memory buffer 206, and a device driver 208 (that includes a pinned memory buffer 210). Similarly, OS image 260 includes a kernel 231, a user application 232 (that includes a message queue 234), a virtual memory buffer 236, and a device driver 238 (that includes a pinned memory buffer 240). Specifically, when user application 202 has data that is to be shared with user application 232, user application 202 stores the data in message queue 204 associated with user application 202 and sends a request to kernel 201 to initiate the transfer of the data to user application 232. Kernel 201 copies the data from message queue 204 to virtual memory buffer 206 and initiates device driver 208 copying the data from virtual memory buffer 206 to pinned memory buffer 210.

To transfer the data to OS image 250, device driver 208 sends a request to hypervisor 216. Responsive to the request from device driver 208, hypervisor 216 initiates copying the data to pinned memory buffer 240 of device driver 238. To make the data accessible to user application 232, device driver 238 copies the data to message queue 234 of user application 232. It should be appreciated that the data sharing process described with respect to FIG. 2 requires: pinning data to be transferred in memory; a number of copy operations (four copy operations in this case); and hypervisor involvement to share data between user applications associated with different OS images.

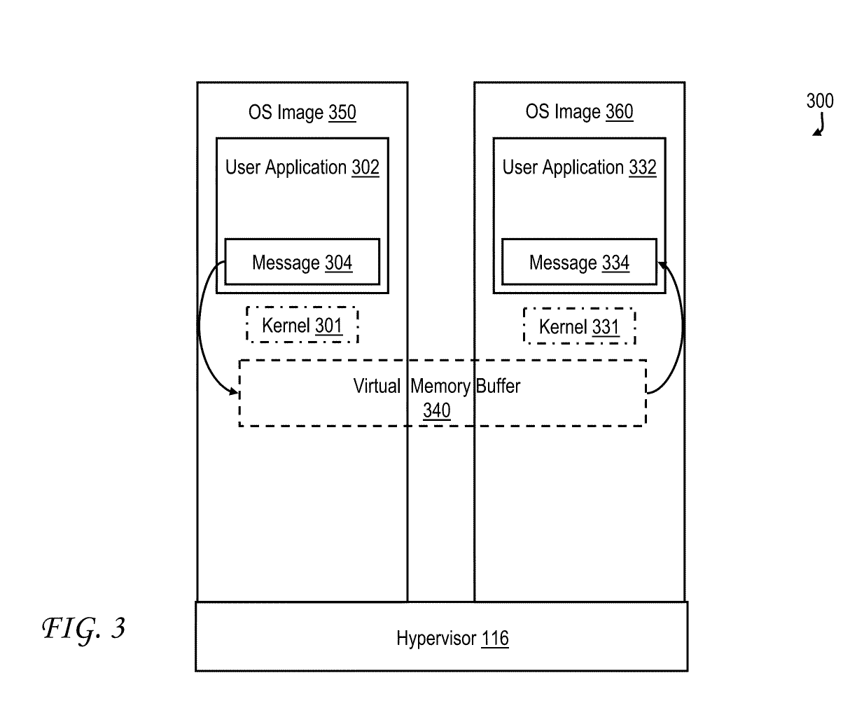

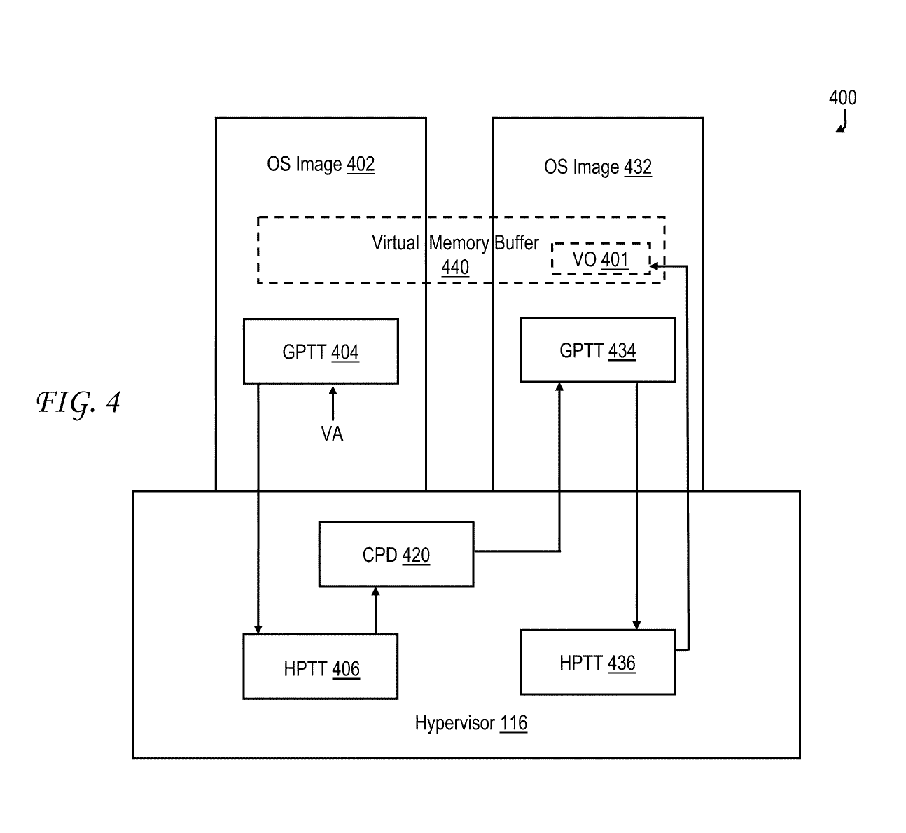

With reference to FIG. 3, a relevant portion of a data processing system 300 is illustrated that utilizes XSHMAT functionality to facilitate data sharing between respective applications (or processes of the applications) associated with OS images 350 and 360. It should be appreciated that hypervisor 116, while employed to initially set-up data structures (e.g., hypervisor page table trees (HPTTs), guest page table trees (GPTTs), and cross-partition descriptors (CPDs), see, for example, FIG. 4) that are utilized to share data between OS images 350 and 360, is not involved in the actual sharing of the data between OS images 350 and 360. As is illustrated, OS image 350 includes a kernel 301 and a user application 302 (that includes a message queue 304). Similarly, OS image 360 includes a kernel 331 and a user application 332 (that includes a message queue 334).

Specifically, when user application 302 has data that is to be shared with user application 332, user application 302 stores the data in message queue 304 associated with user application 302 and sends a request to kernel 301 to initiate sharing the data with user application 332 (i.e., sends a request to create a cross-partition connection). Kernel 301 then creates the cross-partition connection and copies the data from message queue 304 to a virtual memory buffer 340, which is, according to the present disclosure, accessible to user application 332. User application 332 can then connect to virtual memory buffer 340 to access the data by attaching to the cross-partition connection. Specifically, user application 332 may send a request to kernel 331 to copy the data in virtual memory buffer 340 to message queue 334, which is accessible to user application 332. It should be appreciated that the data sharing process described with respect to FIG. 4 does not require pinning data to be shared in memory, reduces the number of copy operations required to share data, and does not require hypervisor involvement to transfer data between user applications associated with different OS images.

With reference to FIG. 4, a relevant portion of a data processing system 400 is illustrated that utilizes a cross-partition shared memory attach, according to the present disclosure, to facilitate data sharing between respective applications (or processes of the applications) associated with OS images 402 and 432. As is illustrated, OS image 432 maintain a virtual object (VO) 401 that is to be shared with an application associated with OS image 402. It should be appreciated that hypervisor 116, while being employed to initially set-up data structures (e.g., HPTTs 406 and 436, GPTTs 404 and 434, and CPD 420) that are utilized to share data between OS images 402 and 432, is not involved in the actual transferring of the data between OS images 402 and 432.

As is illustrated, OS image 402 includes GPTT 404 and OS image 432 includes GPTT 434. While GPTTs 404 and 434 are illustrated as being included within OS images 402 and 432, respectively, it should be appreciated that GPTTs 404 and 434 are only required to be stored in a location that is accessible to OS images 402 and 432. Similarly, while HPTTs 406 and 436 and CPD 420 are illustrated as being included in hypervisor 116, it should be appreciated that HPTTs 406 and 436 and CPD 420 are only required to be stored in a location that is accessible to hypervisor 116 and protected from modification by OS images 402 and 432. In FIG. 4, GPTT 404 is illustrated as receiving a VA (from an associated application, not shown in FIG. 4) that requires translation to a physical address (i.e., a physical address of VO 401) and is associated with an operation (e.g., a read access, a write access, etc.).

GPTT 404 is traversed, based on the received VA, to provide a pointer into HPTT 406. HPTT 406 is then traversed based on the pointer provided by GPTT 404 to provide a pointer into CPD 420. CPD 420 provides a pointer into GPTT 434, which provides a pointer into HPTT 436. Assuming no error occurs, an entry in HPTT 436 (pointed to by the pointer provided by GPTT 434) provides a pointer to VO 401. In this manner, an application executing in OS image 402 can access VO 401, which is maintained by OS image 432, without requiring shared data to be pinned in memory or requiring hypervisor involvement.

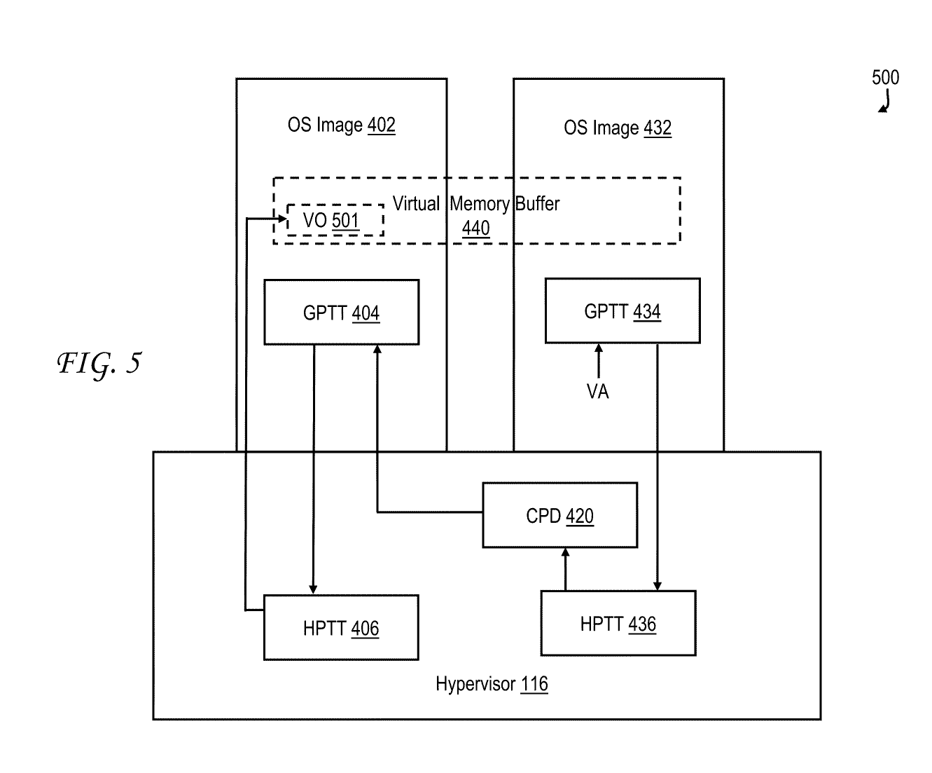

With reference to FIG. 5, a relevant portion of a data processing system 500 is illustrated that implements XSHMAT functionality according to the present disclosure, to facilitate data sharing between respective applications (or processes of the applications) associated with OS images 402 and 432. In FIG. 5 OS image 402 maintains a VO 501 that is to be shared with an application associated with OS image 432. GPTT 434 is illustrated as receiving a VA (from an associated application, not shown in FIG. 5) that requires translation to a physical address (i.e., a physical address of VO 501). GPTT 434 is traversed, based on the received VA, to provide a pointer into HPTT 436. HPTT 436 is then traversed, based on the pointer provided by GPTT 434, to provide a pointer into CPD 420. CPD 420 provides a pointer into GPTT 404, which provides a pointer into HPTT 406.

Assuming no error occurs, an entry in HPTT 406 (pointed to by the pointer provided by GPTT 404) provides a pointer to VO 501. In this manner, an application executing in OS image 432 can access VO 501, which is maintained by OS image 402, without requiring shared data to be pinned in memory or requiring hypervisor involvement. It should be appreciated that when an application of an OS image attempts to access a VO maintained by the OS image, the process described in FIGS. 4 and 5 is not required to access the VO. That is, an application can directly access VOs maintained by an associated OS image. It should also be appreciated in FIGS. 4 and 5 that OS images 402 and 432 are executing on a single data processing system (e.g., data processing system 110 of FIG. 1).

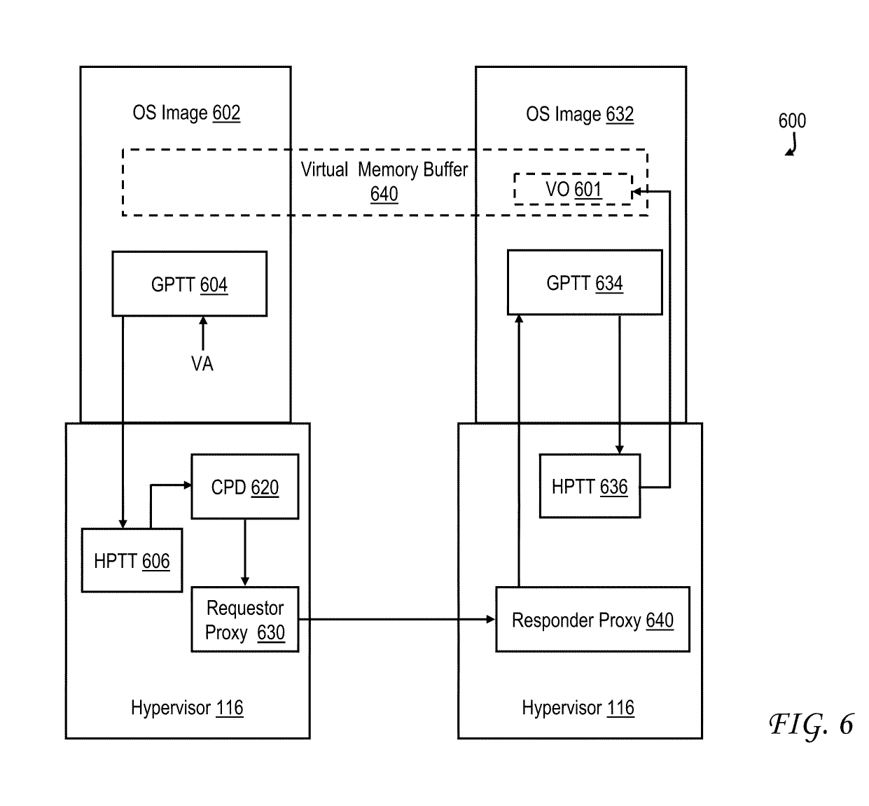

With reference to FIG. 6, a relevant portion of a data processing environment 600 is illustrated that implements XSHMAT functionality to facilitate data sharing between respective applications (or processes of the applications) associated with OS images 602 and 632, which may execute on different hardware platforms. As is illustrated, OS image 632 maintains a virtual object (VO) 601 that is to be shared with an application associated with OS image 602. It should be appreciated that hypervisors 116, which initially set-up data structures (e.g., HPTTs 606 and 636, GPTTs 604 and 634, and CPD 620) that are utilized to share data between OS images 602 and 632, are not involved in the actual transferring of the shared data between OS images 602 and 632. In FIG. 6, requestor proxy 630 and responder proxy 640 are implemented in hardware to facilitate communications between different data processing systems.

As is illustrated, OS image 602 includes GPTT 604 and OS image 632 includes GPTT 634. While GPTTs 604 and 634 are illustrated as being included within OS images 602 and 632, respectively, it should be appreciated that GPTTs 604 and 634 are only required to be stored in a location that is accessible to respective OS images 602 and 632. Similarly, while HPTTs 606 and 636 and CPD 620 are illustrated as being included in respective hypervisors 116, it should be appreciated that HPTTs 606 and 636 and CPD 620 are only required to be stored in a location that is accessible to respective hypervisors 116 and protected from modification by OS images 602 and 632. In FIG. 6, GPTT 604 is illustrated as receiving a VA (from an associated application, not shown in FIG. 6) that requires translation to a physical address (i.e., a physical address of VO 601). GPTT 604 is traversed, based on the received VA, to provide a pointer into HPTT 606. HPTT 606 is then traversed, based on the pointer provided by GPTT 604, to provide a pointer into CPD 620. CPD 620 provides a pointer (which is transferred via requestor proxy 630 and responder proxy 640) into GPTT 634, which provides a pointer into HPTT 636. Assuming no error occurs, an entry in HPTT 636 (pointed to by the pointer provided by GPTT 634) provides a pointer to VO 601. In this manner, an application executing in OS image 602 can access VO 601, which is maintained by OS image 632 executing on another data processing system, without requiring shared data to be pinned in memory or requiring hypervisor involvement.

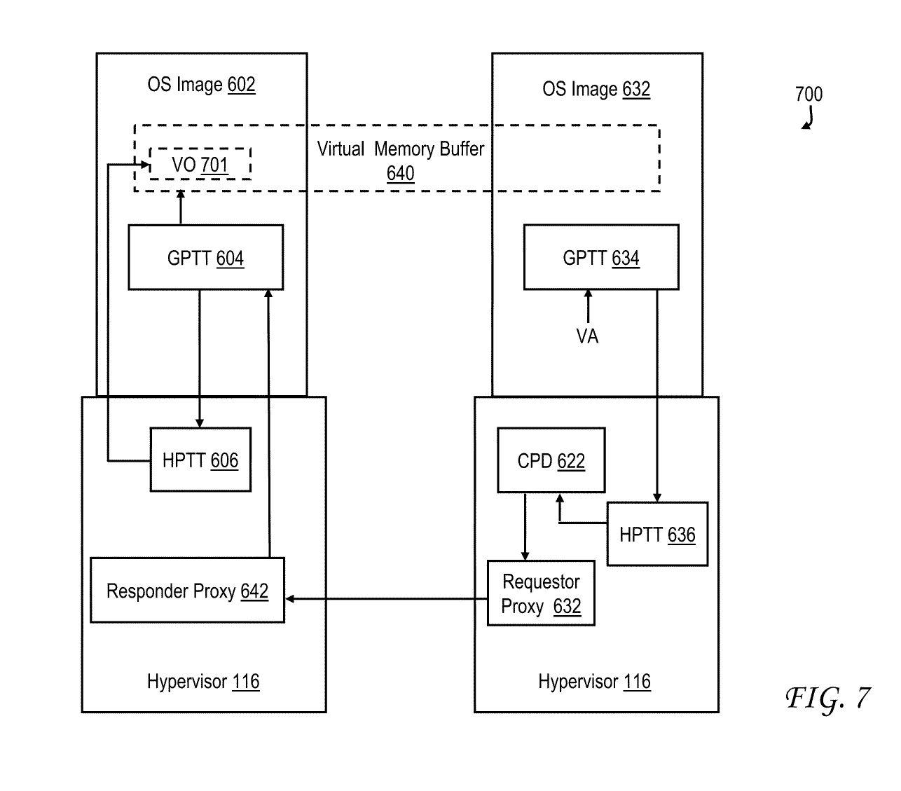

With reference to FIG. 7, a relevant portion of a data processing environment 700 is illustrated that implements XSHMAT functionality to facilitate data sharing between respective applications (or processes of the applications) associated with OS images 602 and 632, which may execute on different hardware platforms. In FIG. 7 OS image 602 maintains VO 701, which is to be shared with an application associated with OS image 632. GPTT 634 is illustrated as receiving a VA (from an associated application, not shown in FIG. 7) that requires translation to a physical address (i.e., a physical address of VO 701). GPTT 634 is traversed, based on the received VA, to provide a pointer into HPTT 636. HPTT 636 is then traversed, based on the pointer provided by GPTT 634, to provide a pointer into CPD 622. CPD 622 provides a pointer (which is transferred via requestor proxy 632 and responder proxy 642) into GPTT 604, which provides a pointer into HPTT 606.

Assuming no error occurs, an entry in HPTT 606 (pointed to by the pointer provided by GPTT 604) provides a pointer to VO 701. In this manner, an application executing in OS image 632 can access VO 701, which is maintained by OS image 602 executing in another data processing system, without requiring shared data to be pinned in memory or requiring hypervisor involvement. It should be appreciated that when an application of an OS image attempts to access a VO maintained by the OS image, the process described in FIGS. 6 and 7 is not required to access the VO. That is, an application can directly access VOs maintained by an associated OS image. It should also be appreciated that in FIGS. 6 and 7 OS images 602 and 632 are executing on different data processing systems (e.g., with reference to FIG. 1, OS image 602 may execute on data processing system 110 and OS image 632 may execute on data processing system 150).

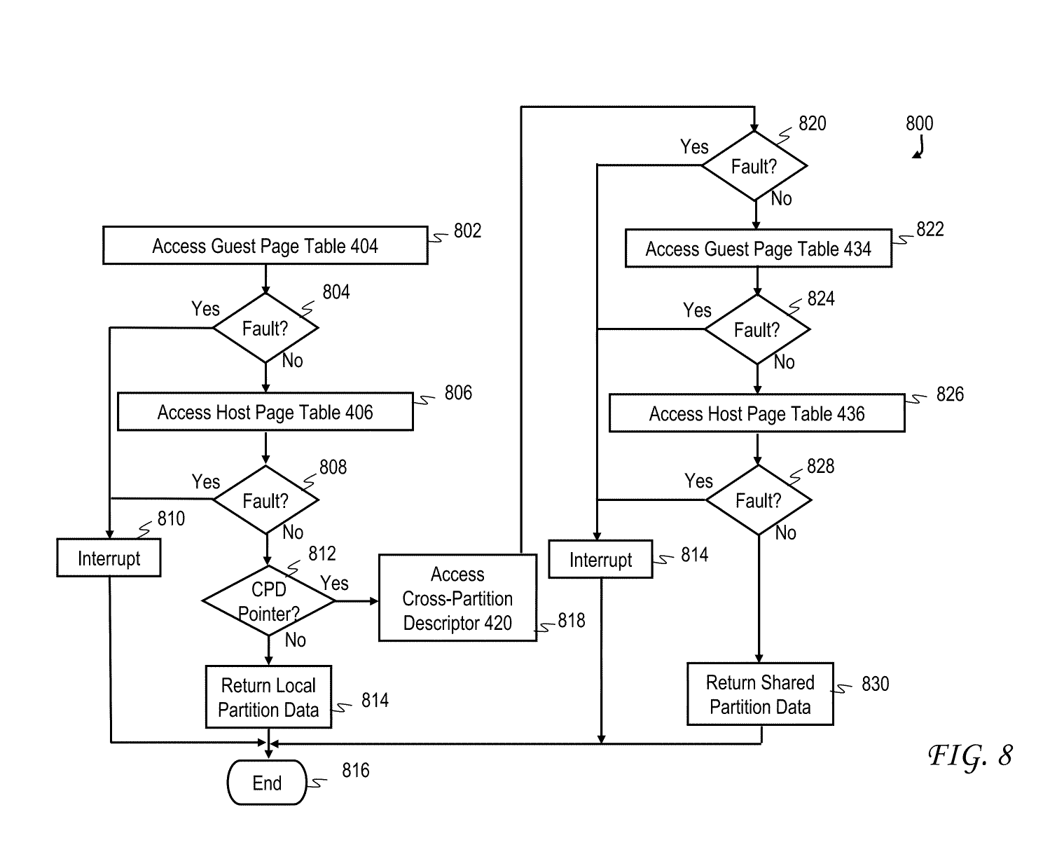

With reference to FIG. 8, a flowchart of an exemplary process 800 for implementing XSHMAT functionality in a data processing environment (e.g., data processing environment 100 of FIG. 1) is illustrated. To aid understanding, process 800 is discussed in conjunction with FIGS. 1 and 4. For example, at least portions of process 800 may be executed by processor 102 of data processing system 110. At block 802, process 800 is initiated (e.g., when a first application executing in OS image 402 desires to access desired data, e.g., VO 401, that may be shared with a second application executing in OS image 432) at which point processor 102 accesses (with a VA) an associated first guest data structure (e.g., GPTT 404) to retrieve a pointer for an associated first host data structure (e.g., HPTT 406). Next, in block 804, processor 102 determines whether a fault occurs (e.g., if GPTT 404 does not include a valid entry for the VA). In response to a fault occurring in block 804, control transfers to block 810 where processor 102 provides an interrupt to a kernel associated with OS image 402. Following block 810, control transfers to block 816 where process 800 terminates.

In response to a fault not occurring in block 804, control transfers to block 806 where processor 102 accesses the first host data structure to retrieve information (which may be a physical address for the desired data or a pointer to a CPD) on a location of the desired data. Next, in block 808, processor 102 determines whether a fault occurs (e.g., if HPTT 406 does not include a valid entry for the pointer provided by GPTT 404). In response to a fault occurring in block 808, control transfers to block 810 and then to block 816. In response to a fault not occurring in block 808, control transfers to block 812 where processor 102 determines whether a pointer provided by the first host data structure is a CPD pointer. In response to the pointer not being a CPD pointer in block 812, control transfers to block 814 where processor 102 returns local partition data for OS image 402 to the associated first application and then to block 816.

In response to the pointer being a CPD pointer in block 812, control transfers to block 818 where processor 102 accesses an associated CPD (e.g., CPD 420) using the CPD pointer provided by the first host data structure. Next, in block 820 processor 102 determines whether a fault occurs (e.g., if the CPD pointer provided by HPTT 406 does not point to a valid entry in CPD 420). In response to a fault occurring in block 820, control transfers to block 814, where processor 102 returns an interrupt to a kernel of OS image 402, and then to block 816. In response to a fault not occurring in block 820, control transfers to block 822, where processor 102 accesses a second guest data structure (e.g., GPTT 434) of a second OS image (e.g., OS image 432). Next, in block 824, processor 102 determines whether a fault occurs (e.g., if an entry pointed to by the CPD does not point to a valid entry in the second guest data structure).

In response to a fault occurring in block 824, control transfers to block 814 where processor 102 returns an interrupt to a kernel executing in OS image 434, and then to block 816. In response to a fault not occurring in block 824, control transfers to block 826 where processor 102 accesses a second host data structure (e.g., HPTT 436) using a pointer provided by the second guest data structure to locate a pointer to the desired data (e.g., VO 401). Next, in block 828, processor 102 determines whether a fault occurs (e.g., if an entry pointed to by the pointer from the second host data structure does not point to a valid entry in virtual memory buffer 440). In response to a fault occurring in block 828, control transfers to block 814, where processor 102 returns an interrupt, and then to block 816. In response to a fault not occurring in block 828, control transfers to block 830, where processor 102 returns shared partition data to the first application associated with OS image 402. Following block 830, control transfers to block 816.

Accordingly, cross-partition shared memory attach functionality has been described herein that advantageously addresses the problems of scaling as shared virtual objects become relatively large and numerous.

In the flow charts above, the methods depicted in FIG. 8 may be embodied in a computer-readable medium containing computer-readable code such that a series of steps are performed when the computer-readable code is executed on a computing device. In some implementations, certain steps of the methods may be combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing, but does not include a computer-readable signal medium. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible storage medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The computer program instructions may also be stored in a computer-readable storage medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage subsystems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for managing shared memory, comprising:
linking address translation data structures used by first and second sharing applications, wherein the first sharing application is managed by a first operating system (OS) and the second sharing application is managed by a second OS that hosts an associated virtual object; and
binding, based on the linking, virtual addresses of the first and second sharing applications to a changeable set of physical addresses that the second OS assigns to the associated virtual object such that the associated virtual object, which is shared by the sharing applications, is pageable by the second OS without permission of the first OS.

2. The method of claim 1, wherein the first OS and the second OS execute on a same data processing system.

3. The method of claim 1, wherein the first and second OSs execute on different data processing systems.

4. The method of claim 1, wherein a single hypervisor maintains the address translation data structures for both of the first and second OSs.

5. The method of claim 1, wherein different hypervisors maintain the address translation data structures for the first OS and the second OS.

6. The method of claim 1, wherein the address translation data structures include guest tree translation data structures that provide guest real addresses and hypervisor tree translation data structures that provide physical addresses.

7. The method of claim 1, wherein the linking is provided by a cross-partition descriptor.

8. A data processing system, comprising:
a memory; and
a processor coupled to the memory, wherein the processor is configured to:
link address translation data structures used by first and second sharing applications, wherein the first sharing application is managed by a first operating system (OS) and the second sharing application is managed by a second OS that hosts an associated virtual object; and
bind, based on the linking, virtual addresses of the first and second sharing applications to a changeable set of physical addresses that the second OS assigns to the associated virtual object such that the associated virtual object, which is shared by the sharing applications, is pageable by the second OS without permission of the first OS.

9. The data processing system of claim 8, wherein the first OS and the second OS execute on a same data processing system.

10. The data processing system of claim 8, wherein the first and second OSs execute on different data processing systems.

11. The data processing system of claim 8, wherein a single hypervisor maintains the address translation data structures for both of the first and second OSs.

12. The data processing system of claim 8, wherein different hypervisors maintain the address translation data structures for the first OS and the second OS.

13. The data processing system of claim 8, wherein the address translation data structures include guest tree translation data structures that provide guest real addresses and hypervisor tree translation data structures that provide physical addresses.

14. The data processing system of claim 8, wherein the linking is provided by a cross-partition descriptor.

15. A computer program product, comprising:
a computer-readable storage device; and
computer code embodied on the computer-readable storage device, wherein the computer code, where executed by a processor, causes the processor to:
link address translation data structures used by first and second sharing applications, wherein the first sharing application is managed by a first operating system (OS) and the second sharing application is managed by a second OS that hosts an associated virtual object; and
bind, based on the linking, virtual addresses of the first and second sharing applications to a changeable set of physical addresses that the second OS assigns to the associated virtual object such that the associated virtual object, which is shared by the sharing applications, is pageable by the second OS without permission of the first OS.

16. The computer program product of claim 15, wherein the first OS and the second OS execute on a same data processing system.

17. The computer program product of claim 15, wherein the first and second OSs execute on different data processing systems.

18. The computer program product of claim 15, wherein a single hypervisor maintains the address translation data structures for both of the first and second OSs.

19. The computer program product of claim 15, wherein different hypervisors maintain the address translation data structures for the first OS and the second OS.

20. The computer program product of claim 15, wherein the address translation data structures include guest tree translation data structures that provide guest real addresses and hypervisor tree translation data structures that provide physical addresses, and wherein the linking is provided by a cross-partition descriptor.
